(19) United States
(12) Patent Application Publication
(10) Pub. No.: US 2026/0307754 A1
(43) Pub. Date: Oct. 8, 2026

(54) INTAKE STRUCTURE OF SADDLE-RIDE VEHICLE

(71) Applicant: HONDA MOTOR CO., LTD., Tokyo (JP)

(72) Inventors: Daisuke NISHIWAKI, ASAKA-SHI (JP); Yusuke UEKI, ASAKA-SHI (JP)

(21) Appl. No.: 19/631,469

(22) Filed: Mar. 27, 2026

(30) Foreign Application Priority Data
Apr. 4, 2025 (JP) 2025-062595

(51) Int. Cl. B62J 40/10; F02M 35/10; F02M 35/16

(52) U.S. Cl. CPC B62J 40/10; F02M 35/10091; F02M 35/162

(57) ABSTRACT

In the intake structure of the saddle-ride vehicle that performs intake pressurization by a center duct, the center duct includes a bent portion between a duct inlet and an air cleaner inlet, and an opening is provided in at least one of upper and lower directions in a front portion of the bent portion.

### INCORPORATION BY REFERENCE

The present application claims priority under 35 U.S.C. § 119 to Japanese Patent Application No. 2025-062595 filed on Apr. 4, 2025. The content of the application is incorporated herein by reference in its entirety.

### BACKGROUND

### Technical Field

The present invention relates to an intake structure of a saddle-ride vehicle.

### Related Art

JP 2017-67019 A discloses an intake structure of a saddle-ride vehicle that performs intake pressurization by a center duct. A vehicle body frame of the saddle-ride vehicle is covered with a cowling, and an inlet of the center duct opens at a front end of the cowling. The center duct extends rearward of a vehicle body while avoiding, for example, left and right front forks of a head pipe and the like, and is connected to an air cleaner inlet.

### SUMMARY

However, in the related art, since the center duct includes a bent portion in order to avoid the left and right front forks and the like, there is a possibility that air subjected to intake pressurization is separated at the bent portion and cannot be stably taken into the air cleaner inlet.

An object of the present invention is to provide an intake structure of a saddle-ride vehicle capable of stably taking in air to an air cleaner inlet.

An aspect of the present invention is an intake structure of a saddle-ride vehicle that performs intake pressurization by a center duct, wherein the center duct includes a bent portion between a duct inlet and an air cleaner inlet; and an opening is provided in at least one of upper and lower directions in a front portion of the bent portion.

In addition, an aspect of the present invention is an intake structure of a saddle-ride vehicle that performs intake pressurization by a center duct, wherein the center duct includes a bent portion between a duct inlet and an air cleaner inlet, and an opening is provided in an upper portion of a front end of the bent portion.

According to the aspect of the present invention, air can be stably sucked into the air cleaner inlet.

### BRIEF DESCRIPTION OF DRAWINGS

FIG. 1 is a side view of a saddle-ride vehicle according to an embodiment of the present invention;

FIG. 2 is a side view illustrating a center duct disposed inside a cowling;

FIG. 3 is a perspective view when the center duct is viewed from below;

FIG. 4 is a plan view illustrating a state in which the center duct and an air cleaner are connected;

FIG. 5 is a side view illustrating the state in which the center duct and the air cleaner are connected;

FIG. 6 is a conceptual view simulating an intake flow inside the center duct in a case where slits are provided;

FIG. 7 is a comparative view in a case where the slits are not provided;

FIG. 8 is a conceptual view simulating an intake flow in the center duct in a case where slits are provided; and

FIG. 9 is a comparative view in a case where the slits are not provided.

### DETAILED DESCRIPTION

Hereinafter, embodiments of the present invention will be described with reference to the drawings. Note that in the description, directions such as front, rear, left, right, up, and down are identical to directions with respect to a vehicle body, unless otherwise specified. In the drawings, reference sign FR denotes frontward of the vehicle body, reference sign UP denotes upward of the vehicle body, and reference sign LH denotes leftward of the vehicle body.

### Embodiments

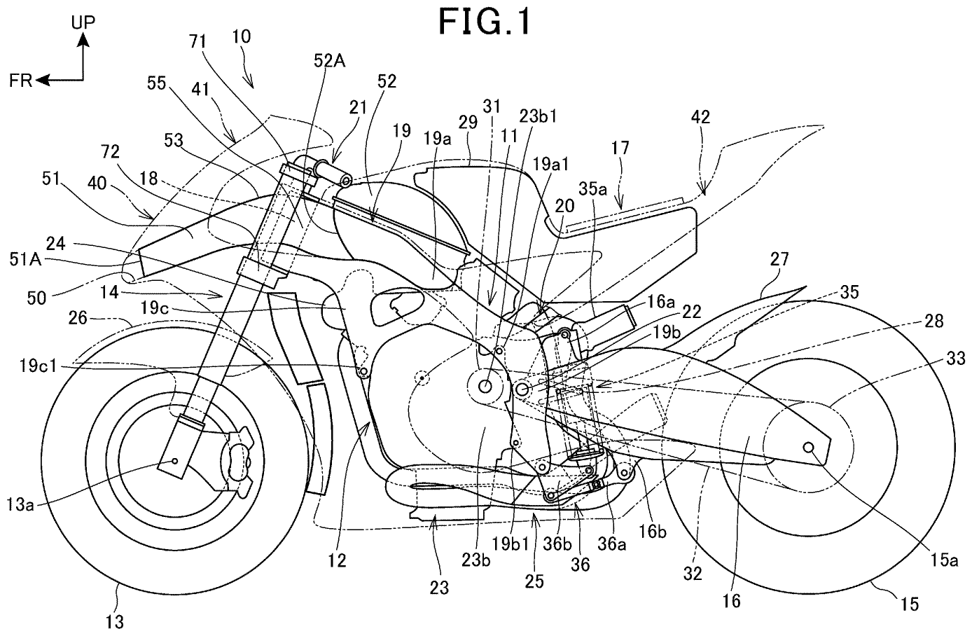

FIG. 1 is a side view of a saddle-ride vehicle 10 according to an embodiment of the present invention.

The saddle-ride vehicle 10 is a vehicle including a vehicle body frame 11, a power unit 12 supported by the vehicle body frame 11, front forks 14 that support a front wheel 13 so as to be steerable, swing arms 16 that support a rear wheel 15, and a seat 17 for a rider.

The saddle-ride vehicle 10 is a vehicle on which the rider sits so as to straddle the seat 17. The seat 17 is provided above a rear portion of the vehicle body frame 11.

The vehicle body frame 11 includes a head pipe 18 provided at a front end portion of the vehicle body frame 11, a front frame 19 located behind the head pipe 18; and a rear frame 20 located behind the front frame 19. A front end portion of the front frame 19 is connected to the head pipe 18.

The seat 17 is supported by the rear frame 20.

The front forks 14 are supported by the head pipe 18 so as to be steerable to the right and left. The front wheel 13 is supported by an axle 13a provided at lower end portions of the front forks 14. A handlebar 21 for steering to be gripped by the rider is attached to upper end portions of the front forks 14.

The swing arms 16 are supported by a pivot shaft 22 supported by the vehicle body frame 11. The pivot shaft 22 is a shaft extending horizontally in a vehicle width direction. The pivot shaft 22 is inserted into front end portions of the swing arms 16. The swing arms 16 swing up and down with the pivot shaft 22 as a center.

The rear wheel 15 is supported by an axle 15a provided at rear end portions of the swing arms 16.

The power unit 12 is disposed between the front wheel 13 and the rear wheel 15, and is supported by the vehicle body frame 11.

The power unit 12 is an internal combustion engine. The power unit 12 includes a crankcase 23 and a cylinder portion 24 that accommodates a reciprocating piston. An exhaust device 25 is connected to an exhaust port of the cylinder portion 24.

Output of the power unit 12 is transmitted to the rear wheel 15 by a driving force transmission member that connects the power unit 12 and the rear wheel 15.

In addition, the saddle-ride vehicle 10 includes a front fender 26 that covers the front wheel 13 from above, a rear fender 27 that covers the rear wheel 15 from above, steps 28 on which the rider places his/her feet; and a fuel tank 29 that stores a fuel to be used by the power unit 12.

The front fender 26 is attached to the front forks 14. The rear fender 27 and the steps 28 are provided below the seat 17. The fuel tank 29 is supported by the vehicle body frame 11.

In the vehicle body frame 11 of the present embodiment, the left and right front forks 14 are located on both sides of the head pipe 18, upper portions of the front forks 14 are connected by a top bridge 71, and middle portions between upper and lower portions of the front forks 14 are connected by a bottom bridge 72.

The front frame 19 includes a pair of left and right main frame portions 19a extending rearward and downward from the head pipe 18, pivot frame portions 19b extending downward from rear ends of the main frame portions 19a, and a pair of left and right down frame portions 19c extending downward from front end portions of the main frame portions 19a.

Unit hangers 19c1 that support a front portion of the power unit 12 are provided at lower end portions of the down frame portions 19c. Unit support portions 19a1 that support an upper rear side of the power unit 12 are provided at rear end portions of the main frame portions 19a. Unit support portions 19b1 that support a rear portion of the power unit 12 are provided at lower end portions of the pivot frame portions 19b.

The power unit 12 is supported on the front frame 19 by the unit hangers 19c1 and the unit support portions 19a1, 19b1. The power unit 12 of the present embodiment is an internal combustion engine.

Hereinafter, the power unit 12 is referred to as the engine 12. The engine 12 includes the cylinder portion 24, and an intake device (not illustrated) is attached to the cylinder portion 24. Although not illustrated, the intake device has an intake box, a throttle body disposed inside the intake box, a fuel injection valve, and the like.

A transmission 23b provided in the crankcase 23 of the engine 12 includes an output shaft 23b1 protruding laterally. A drive sprocket 31 is fixed to the output shaft 23b1. An endless drive chain 32 is wound around the drive sprocket 31. The drive chain 32 extends toward the rear wheel 15 and is wound around a driven sprocket 33 provided on the rear wheel 15. Accordingly, a rotational force as a driving force is transmitted from the engine 12 to the rear wheel 15.

The rear wheel 15 is rotatably supported by the rear end portions of the swing arms 16. As for the swing arms 16, the front end portions of the swing arms 16 are swingably supported by the pivot frame portions 19b via the pivot shaft 22.

A cushion unit 35 is attached to each of the swing arms 16. Particularly, a cushion attachment portion 16a is formed in a front upper portion of the swing arm 16. An upper end portion of the cushion unit 35 extending in an up-down direction is swingably attached to the cushion attachment portion 16a. A lower end portion of the cushion unit 35 is attached to the lower end portion of each of the pivot frame portions 19b via a link mechanism 36 having a first link 36a extending in a front-rear direction and an inverted triangular second link 36b. A reservoir 35a for storing hydraulic oil is provided in an upper portion of the cushion unit 35. A link attachment portion 16b to which the first link 36a is connected is formed in a lower portion of the swing arm 16.

The vehicle body frame 11 is covered with a cowling 40. A windscreen 41 is supported on a front upper portion of the cowling 40. The fuel tank 29 is attached above the main frame portions 19a via a seat cowl 42. The seat 17 is attached to the seat cowl 42.

### First Embodiment of Intake Structure

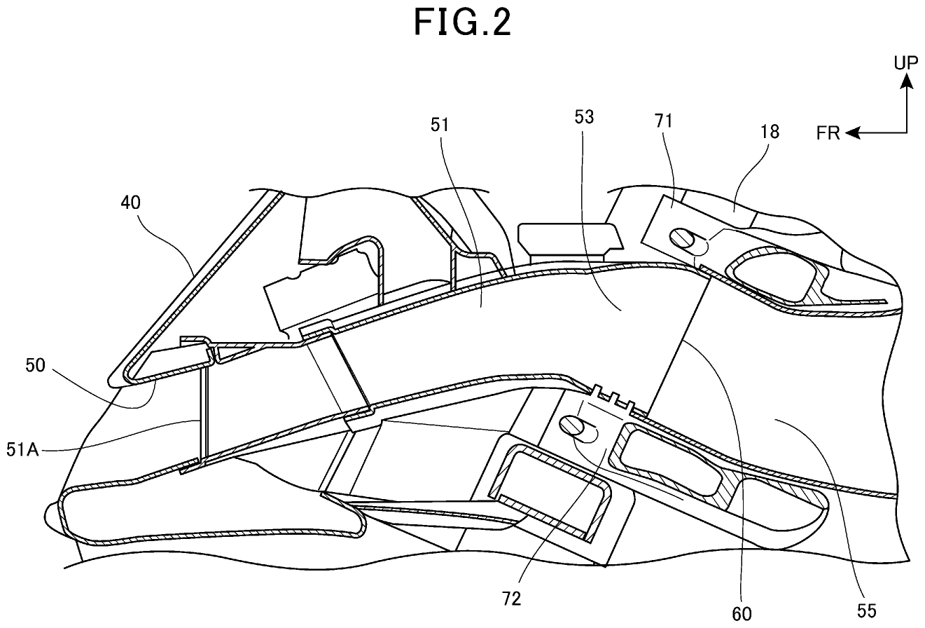

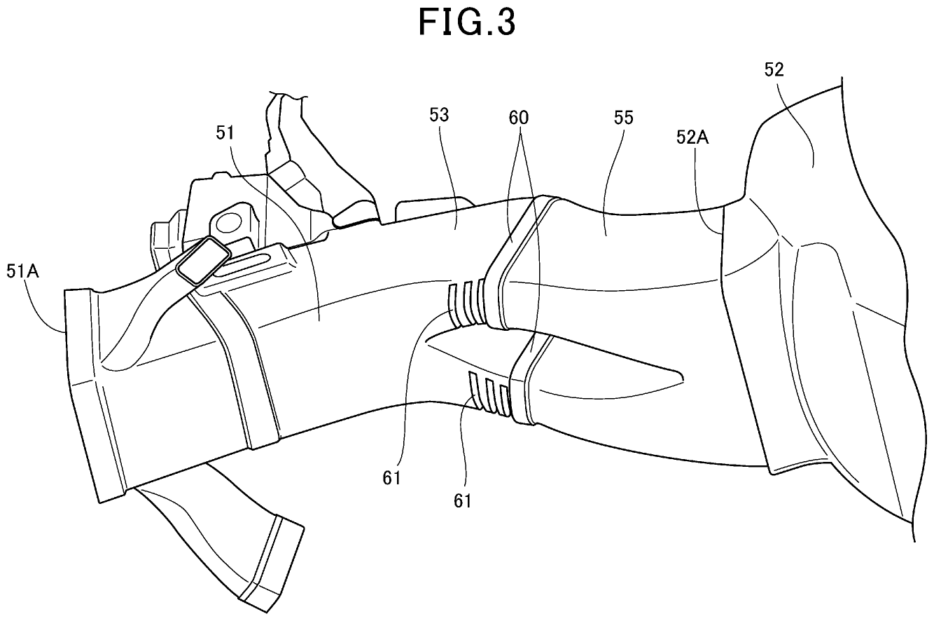

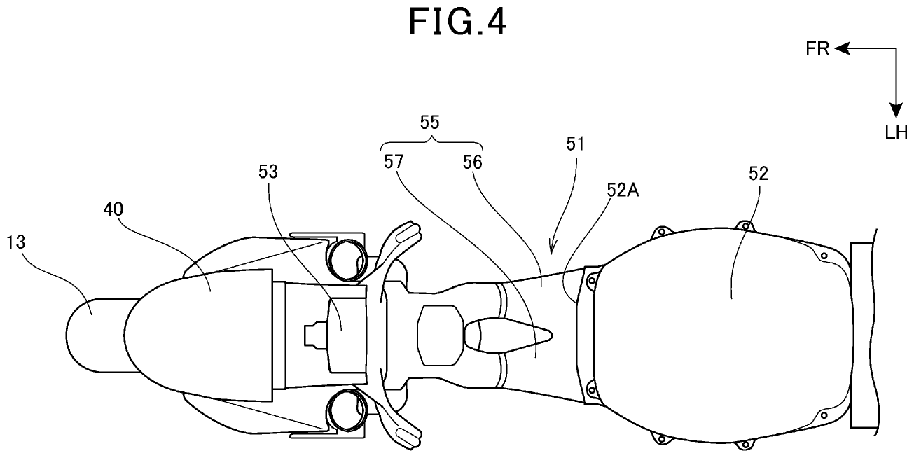

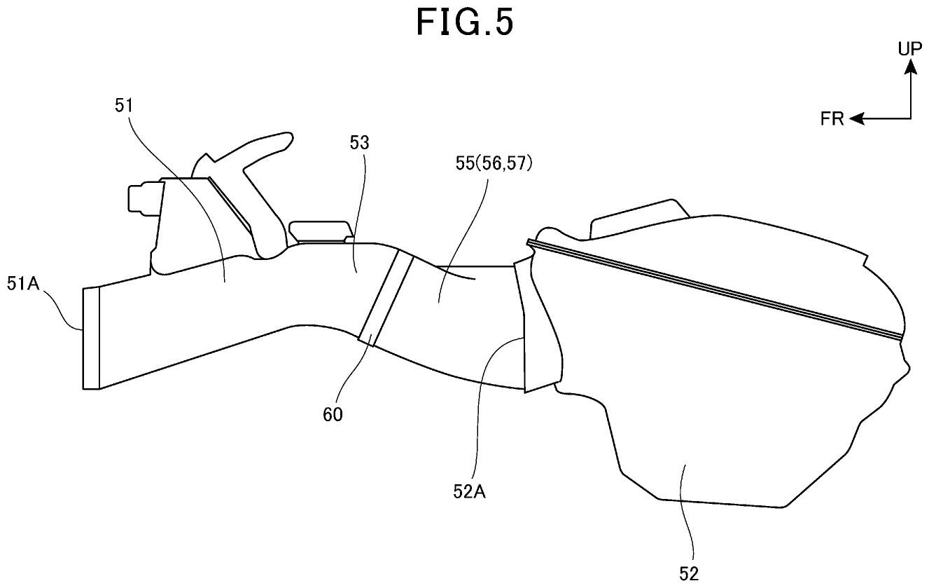

FIG. 2 is a side view illustrating a center duct 51 disposed inside the cowling 40, FIG. 3 is a perspective view when the center duct 51 is viewed from below, FIG. 4 is a plan view illustrating a state in which the center duct 51 and an air cleaner 52 are connected, and FIG. 5 is a side view illustrating the state in which the center duct 51 and the air cleaner 52 are connected.

As illustrated in FIG. 2, an intake opening 50 for taking in traveling air is formed at a center of a front end of the cowling 40 in the vehicle width direction, and an inlet 51A of the center duct 51 is connected to the intake opening 50. The center duct 51 extends rearward of the vehicle body while inclining obliquely upward until reaching a vicinity of the head pipe 18. The center duct 51 includes a throttle portion 53 passing between the left and right front forks 14 located on both sides of the head pipe 18, and the throttle portion 53 passes between the top bridge 71 and the bottom bridge 72. That is, the center duct 51 extends rearward of the vehicle body while avoiding the head pipe 18.

As illustrated in FIGS. 3 and 4, a branch portion 55 is continued to a rear end of the throttle portion 53. The branch portion 55 branches leftward and rightward in the width direction behind the head pipe 18. Hereinafter, a duct on a right side of the vehicle body is referred to as a right duct 56, and a duct on a left side of the vehicle body is referred to as a left duct 57.

The branch portion 55 is located below the fuel tank 29.

Although not illustrated, a fuel pipe system of the fuel tank 29 is passed between the right duct 56 and the left duct 57, and the fuel pipe system is connected to the engine 12. That is, the center duct 51 branches while avoiding the fuel pipe system of the fuel tank 29 and extends rearward of the vehicle body.

As illustrated in FIG. 5, each of the ducts 56, 57 is formed to descend rearward of the vehicle body and extend obliquely upward, and is connected to the inlet 52A of the air cleaner 52.

As illustrated in FIG. 2, the center duct 51 includes bent portions 60 at the rear end of the throttle portion 53 in order to pass between the top bridge 71 and the bottom bridge 72. As illustrated in FIG. 3, the bent portions 60 are formed between the inlet (the duct inlet) 51A of the center duct 51 and the inlet (the air cleaner inlet) 52A of the air cleaner 52.

As illustrated in FIG. 2, the bent portion 60 behind the throttle portion 53 is located between the top bridge 71 and the bottom bridge 72. As illustrated in FIG. 3, the bent portion 60 is formed at each of inlets of the right duct 56 and the left duct 57, and slits 61 communicating with an outside are formed at a lower end of each of the inlets of the right duct 56 and the left duct 57. The slits 61 are formed in a front portion of each of the bent portions 60 behind the throttle portion 53. The plurality of slits 61 extend in the vehicle width direction and are provided at intervals in the front-rear direction of the vehicle body. Note that a number of slits 61 may be one.

The slits 61 are an example of opening. The opening is not limited to the slits 61, and a shape of a hole is not limited as long as the hole communicates with the outside.

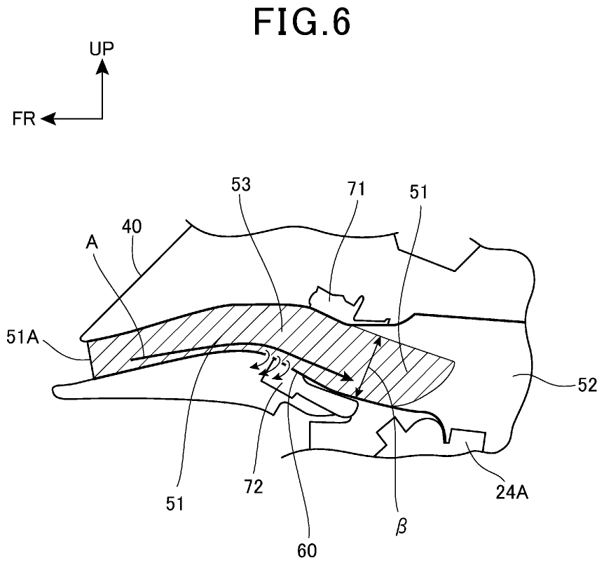

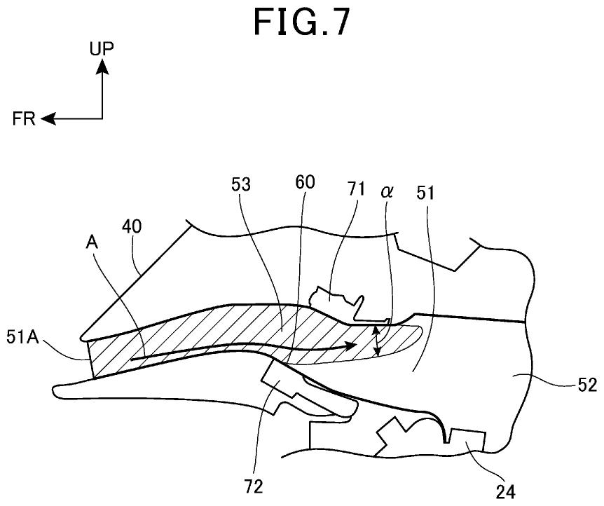

FIG. 6 is a conceptual view simulating an intake flow inside the center duct 51 in a case where the slits 61 are provided. FIG. 7 is a comparative view in a case where the slits 61 are not provided. In each of the drawings, a hatched portion indicates a state of the intake flow.

In the comparative view of FIG. 7 in which the slits 61 are not provided, the intake flow (arrow A) inside the center duct 51 separates in the front portion of each of the bent portions 60 behind the throttle portion 53.

Due to this separation phenomenon, the intake flow at the rear end of the bent portion 60 inside the center duct 51 concentrates on an upper side of an inside of the duct and hardly flows to a lower side of the inside of the duct. That is, when the separation phenomenon occurs, an actual passage area α inside the duct decreases, a flow velocity increases, and a pressure loss of the intake flow becomes larger. As a result, a ram pressure effectiveness decreases.

As illustrated in FIG. 6, when the slits 61 are provided on the lower side of the front end of each of the bent portions 60 behind the throttle portion 53, the air in a separation region is sucked out to the outside through the slits 61.

According to this, the intake flow (arrow A) does not concentrate on the upper side of the inside of the duct, and as illustrated in the drawing, the intake flow substantially uniformly flows using entire upper and lower regions, and becomes an intake flow effectively using an entire passage area β inside the duct. According to this, the flow velocity of the intake flow in the duct decreases, the pressure loss of the intake flow decreases, and the air intake into the inlet 52A of the air cleaner 52 can be stably performed. As a result, the ram pressure effectiveness is improved.

A position where the slits 61 are provided is not limited to the position on the lower side of the front end of each of the bent portions 60 behind the throttle portion 53. The position may be any position as long as the separation of the air flow inside the duct can be effectively suppressed. For example, when the separation of the air flow occurs on an upper side of the rear end of the bent portion 60, the slits 61 are provided on the upper side of the rear end of the bent portion 60. In addition. a size of each of the slits 61 is determined in consideration of an outflow loss of air from the slit 61. The size of the slit 61 is determined such that an effect of suppressing the separation is superior to the outflow loss. Note that, according to simulation results, it is found that the effect of suppressing the separation is superior even if there is an outflow loss from the slits 61.

As described above, according to the first embodiment, in the intake structure of the saddle-ride vehicle 10 in which the intake pressurization is performed by the center duct 51, the center duct 51 includes the bent portions 60 between the duct inlet 51A and the inlet 52A of the air cleaner 52, and the slits 61 are provided on the lower side in the up-down direction in the front portion of each of the bent portions 60. Note that when the fluid separation occurs on the upper side in the up-down direction in the rear portion of each of the bent portions 60 due to the shape of the center duct 51, the slits 61 are provided on the upper side in the up-down direction in the rear portion of the bent portion 60.

According to this constitution, the air in the separation region is sucked out to the outside through the slits 61, and the intake flow becomes an intake flow effectively using the entire passage area in the duct.

As a result, the flow velocity of the intake flow inside the duct decreases, and the pressure loss of the intake flow decreases, thereby improving the ram pressure effectiveness. It is possible to stably perform the air intake into the inlet 52A of the air cleaner 52.

In the first embodiment, the center duct 51 includes the throttle portion 53 passing between the left and right front forks 14 of the head pipe 18, and the slits 61 on the lower side of the front end of the bent portion 60 behind the throttle portion 53.

According to this constitution, the slits 61 are provided on the lower side of the front end of the bent portion 60, and the separation can be suppressed by generating a pressure difference in the separation portion of the intake air. As a result, the flow velocity of the intake flow inside the duct decreases, and the pressure loss of the intake flow decreases, thereby improving the ram pressure effectiveness. It is possible to stably perform the air intake into the inlet 52A of the air cleaner 52.

In the first embodiment, the center duct 51 is branched leftward and rightward in the width direction behind the head pipe 18, and the slits 61 are provided in the branch portion 55.

The branch portion 55 has the right duct 56 and the left duct 57, and the slits 61 are formed at the lower end of each of the inlets of the right duct 56 and the left duct 57.

According to this constitution, since the slits 61 are provided at the lower end of each of the inlets of the right duct 56 and the left duct 57 each having a reduced duct diameter, the flow velocity of the intake flow at a location where the ram pressure increases decreases, the pressure loss of the intake flow decreases, and the ram pressure effectiveness is improved. It is possible to stably perform the air intake into the inlet 52A of the air cleaner 52.

In the first embodiment, one or more slits 61 are provided in the front-rear direction.

A total opening area of the slits 61 can be determined in consideration of the outflow loss of the air from the slits 61 such that the effect of suppressing the separation is superior to the outflow loss.

### Second Embodiment of Intake Structure

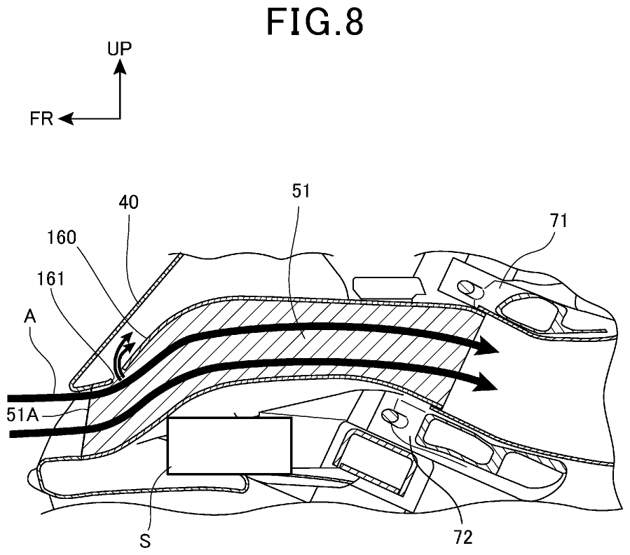

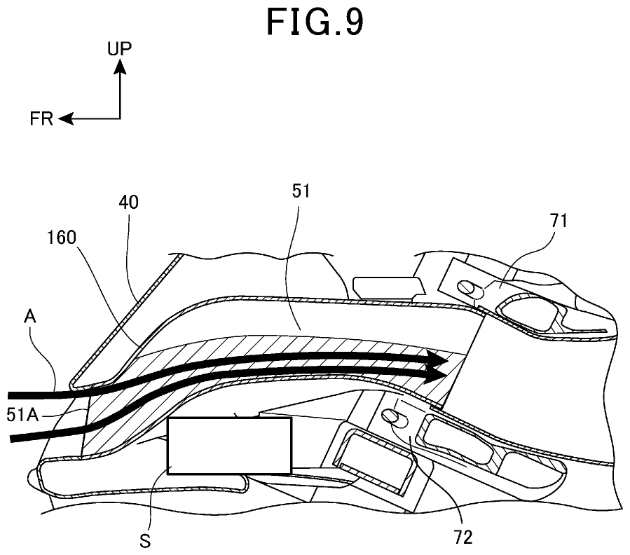

FIG. 8 is a conceptual view simulating an intake flow inside the center duct 51 in a case where slits 161 are provided. FIG. 9 is a comparative view in a case where the slits 161 are not provided. In each of the drawings, a hatched portion indicates a state of the intake flow.

Referring to the conceptual view of FIG. 8, a space S is formed in a lower region of a vicinity of the inlet 51A of the center duct 51, and components (not illustrated) are disposed in the space S.

In such a case, the center duct 51 is bent upward from the vicinity of the inlet 51A in order to avoid the components (not illustrated), extends rearward of the vehicle body after avoiding the components (not illustrated), and passes between the top bridge 71 and the bottom bridge 72. That is, the center duct 51 includes a bent portion 160 in an upper portion in the vicinity of the inlet 51A.

The slits 161 are provided on an upper side of the front end of the bent portion 160. The plurality of slits 161 extend in the vehicle width direction and are provided at intervals in the front-rear direction of the vehicle body (see FIG. 3). Note that a number of slits 161 may be one.

In the comparative view of FIG. 9 in which the slits 161 are not provided, the intake flow (arrow A) inside the center duct 51 separates at the rear end of the bent portion 160.

Due to this separation phenomenon, the intake flow at the rear end of the bent portion 160 inside the center duct 51 concentrates on the lower side of the inside of the duct and hardly flows to the upper side of the inside of the duct. That is, since the separation phenomenon occurs on the upper side of the inside of the duct, the actual passage area inside the duct decreases, the flow velocity increases, and the pressure loss of the intake flow increases.

As a result, a ram pressure effectiveness decreases.

As illustrated in FIG. 8, when the slits 161 are provided on the upper side of the front end of the bent portion 160, the air in the separation region is sucked out to the outside through the slits 161.

According to this, the intake flow (arrow A) does not concentrate on the lower side of the inside of the duct, and as illustrated in the drawing, the intake flow substantially uniformly flows using entire upper and lower regions, and becomes an intake flow effectively using an entire passage area inside the duct. According to this, the flow velocity of the intake flow in the duct decreases, the pressure loss of the intake flow decreases, and the air intake into the inlet 52A of the air cleaner 52 can be stably performed. As a result, the ram pressure effectiveness is improved.

A position where the slits 161 are provided may be any position as long as the separation of the air flow inside the duct can be effectively suppressed, and is not limited to the front side of the bent portion 160.

According to the second embodiment, in the intake structure of the saddle-ride vehicle 10 in which the intake pressurization is performed by the center duct 51, the bent portion 160 is provided between the duct inlet 51A and the inlet 52A of the air cleaner 52, and the plurality of slits 161 are provided on the upper side of the front end of the bent portion 160.

According to this constitution, when the air flow separation occurs on the upper side of the front end of the bent portion 160 provided in the center duct 51, the flow velocity of the intake flow inside the duct decreases, the pressure loss of the intake flow decreases, and the ram pressure effectiveness is improved. It is possible to stably perform the air intake into the inlet 52A of the air cleaner 52.

### Other Embodiments

Each of the embodiments described above is merely one aspect of the present invention, and can be arbitrarily modified and applied within a scope not departing from the spirit of the present invention.

For example, when there are a plurality of bent portions in the center duct 51, the slit 61 may be provided in the bent portion having the highest effect of suppressing separation, or the slits 61 may be provided in the plurality of bent portions. At this time, the total opening area of the slits 61 can be determined in consideration of the outflow loss of the air from the slits 61 such that the effect of suppressing the separation is superior to the outflow loss.

### Constitutions Supported by Above Embodiments

The embodiments described above support the following constitutions.
(Constitution 1) In an intake structure of a saddle-ride vehicle that performs intake pressurization by a center duct, the center duct includes a bent portion between a duct inlet and an air cleaner inlet, and an opening is provided in at least one of upper and lower directions in a front portion of the bent portion.

According to this constitution, air in a separation region is sucked out to an outside through the opening, and an intake flow becomes an intake flow effectively using an entire passage area inside the duct. According to this, a flow velocity of the intake flow inside the duct decreases, a pressure loss of the intake flow decreases, and a ram pressure effectiveness is improved, so that the air intake into the inlet of the air cleaner can be stably performed.
(Constitution 2) The intake structure of a saddle-ride vehicle according to constitution 1, wherein the center duct includes a throttle portion passing between left and right front forks of a head pipe, and the opening is provided on a lower side of a front end of the bent portion behind the throttle portion.

According to this constitution, a pressure difference is generated in a separation portion of the intake air, and the separation can be suppressed. According to this, the flow velocity of the intake flow inside the duct decreases, the pressure loss of the intake flow decreases, and the ram pressure effectiveness is improved, so that the air intake into the inlet of the air cleaner can be stable.
(Constitution 3) The intake structure of a saddle-ride vehicle according to Constitution 1 or Constitution 2, wherein the center duct is branched leftward and rightward in a width direction behind the head pipe, and the opening is provided in the branch portion.

According to this constitution, since the opening is provided in the branch portion having a reduced duct diameter, the flow velocity of the intake flow at the portion where a ram pressure is high decreases, the pressure loss of the intake flow decreases, and the ram pressure effectiveness is improved. The air intake into the inlet of the air cleaner is stabilized.
(Constitution 4) The intake structure of a saddle-ride vehicle according to any one of Constitutions 1 to 3, wherein one or a plurality of the openings are provided in a front-rear direction.

According to this constitution, a total opening area of the opening can be determined in consideration of the outflow loss of air from the opening such that the effect of suppressing the separation is superior to the outflow loss.
(Constitution 5) An intake structure of a saddle-ride vehicle that performs intake pressurization by a center duct, wherein the center duct includes a bent portion between a duct inlet and an air cleaner inlet, and an opening is provided on an upper side of a front end of the bent portion.

According to this constitution, when air flow separation occurs on the upper side of the front end of the bent portion, the flow velocity of the intake flow inside the duct decreases, the pressure loss of the intake flow decreases, and the ram pressure effectiveness is improved. The air intake into the inlet of the air cleaner is stabilized.

### REFERENCE SIGNS LIST

10 saddle-ride vehicle
12 engine (power unit)
14 front fork
18 head pipe
40 cowling
51 center duct
51A inlet
52 air cleaner
52A inlet
53 throttle portion
55 branch portion
60, 160 bent portion
61, 161 slit (opening)
71 top bridge
72 bottom bridge
56 right duct
57 left duct

What is claimed is:

1. An intake structure of a saddle-ride vehicle that performs intake pressurization by a center duct, wherein
the center duct includes a bent portion between a duct inlet and an air cleaner inlet, and
an opening is provided in at least one of upper and lower directions on a front portion of the bent portion.

2. The intake structure of a saddle-ride vehicle according to claim 1, wherein
the center duct includes a throttle portion passing between left and right front forks of a head pipe, and
the opening is provided on a lower side of a front end of the bent portion behind the throttle portion.

3. The intake structure of a saddle-ride vehicle according to claim 2, wherein
the center duct is branched leftward and rightward in a width direction behind the head pipe, and
the opening is provided in a branch portion.

4. The intake structure of a saddle-ride vehicle according to claim 1, wherein one or a plurality of the openings are provided in a front-rear direction.

5. An intake structure of a saddle-ride vehicle that performs intake pressurization by a center duct, wherein
the center duct includes a bent portion between a duct inlet and an air cleaner inlet, and
an opening is provided on an upper side of a front end of the bent portion.
